(19) United States
(12) Patent Application Publication
(10) Pub. No.: US 2007/0260460 A1
(43) Pub. Date: Nov. 8, 2007

(54) METHOD AND SYSTEM FOR ANNOUNCING AUDIO AND VIDEO CONTENT TO A USER OF A MOBILE RADIO TERMINAL

(76) Inventor: Edward Craig Hyatt, Durham, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/381,770

(22) Filed: May 5, 2006

(51) Int. Cl. G10L 13/08

(52) U.S. Cl. 704/260

(57) ABSTRACT

An electronic equipment for playing audiovisual content to a user and announcing information associated with the audiovisual content. The electronic equipment may include an audiovisual data player for playing back audiovisual data; a synthesizer for converting text data associated with the audiovisual data into a representation of the text data for audible playback of the text to a user; and a controller that controls the synthesizer and the audiovisual data player to play back the text data in association with playback of the audiovisual data to announce the audiovisual data to the user.

### TECHNICAL FIELD OF THE INVENTION

The present invention relates generally to electronic equipment, such as electronic equipment for engaging in voice communications and/or for playing back audiovisual content to a user. More particularly, the invention relates to a method and system for announcing audio and/or video content to a user of a mobile radio terminal.

### DESCRIPTION OF THE RELATED ART

Mobile and/or wireless electronic devices are becoming increasingly popular. For example, mobile telephones and portable media players are now in wide-spread use. In addition, the features associated with certain types of electronic device have become increasingly diverse. To name a few examples, many electronic devices have cameras, text messaging capability, Internet browsing functionality, electronic mail capability, video playback capability, audio playback capability, image display capability and hands-free headset interfaces.

As indicated, some electronic devices include audio and/or video playback features. Audio playback may include opening an audio file from the device's memory, decoding audio data contained within the file and outputting sounds corresponding to the decoded audio for listening by the user. The sounds may be output, for example, using a speaker of the device or using an earpiece, such as wired “ear buds” or a wireless headset assembly. Video playback may include opening a video file, decoding video data and outputting a corresponding video signal to drive a display. Video playback also may include decoding audio data associated with the video data and outputting corresponding sounds to the user.

In other situations, the device may be configured to play back received audio data. For instance, mobile radio compatible devices may have a receiver for tuning to a mobile radio channel or a mobile television channel. Mobile radio and video services typically deliver audio data by downstreaming, such as part of a time-sliced data stream in which the audio and/or video data for each channel is delivered as data bursts in a respective time slot of the data stream. The device may be tuned to a particular channel of interest so that the data bursts for selected channel are received, buffered, reassembled, decoded and output to the user.

Many audio and video files, including stored audio and video files and streaming audio and video data, contain headers identifying information about the corresponding content. For example, a music (or song) file header may identify the title of the song, the artist, the album name and the year in which the work was recorded. This information may be used to catalog the file and, during playback, display song information as text on a visual display to the user. However, in many situations, it may be inconvenient for the user to view the display to read any displayed information. Furthermore, the display of information is limited to the data contained in the header. Information regarding video content is visually displayed in the same manner.

### SUMMARY

According to one aspect of the invention, a mobile radio terminal includes a radio circuit for enabling call completion between the mobile radio terminal and a called or calling device; and a text-to-speech synthesizer for converting text data to a representation of the text data for audible playback of the text to a user.

According to another aspect, the converted text data is derived from a header associated with audiovisual data.

According to another aspect, the mobile radio terminal further includes an audiovisual data player for playing the audiovisual data back to the user and wherein the converted text data is played back in association with playback of the audiovisual data to announce the audiovisual data to the user.

According to another aspect, the converted text data from the header is merged with filler audio to simulate a human announcer.

According to another aspect of the invention, an electronic equipment for playing audiovisual content to a user and announcing information associated with the audiovisual content includes an audiovisual data player for playing back audiovisual data; a synthesizer for converting text data associated with the audiovisual data into a representation of the text data for audible playback of the text to a user; and a controller that controls the synthesizer and the audiovisual data player to play back the text data in association with playback of the audiovisual data to announce the audiovisual data to the user.

According to another aspect, converted text data associated with the audiovisual data is merged with filler audio to simulate a human announcer.

According to another aspect, the electronic equipment further includes an audio mixer for combining an audio output of the audiovisual data player and an output of the synthesizer at respective volumes under the control of the controller.

According to another aspect, the text data is audibly announced at a time selected from one of before playback of the audiovisual data, after playback of the audiovisual data or during the playback of the audiovisual data.

According to another aspect, the text data is derived from a header of an audiovisual file containing the audiovisual data.

According to another aspect, the electronic equipment further includes a memory for storing the audiovisual file.

According to another aspect, plural units of audiovisual data are played back and text data is played back for each audiovisual data unit playback, and the controller changes an announcement style of the text data playback from one audiovisual data playback to a following audiovisual data playback.

According to another aspect, the controller controls the synthesizer to apply a persona to the conversion of the text data.

According to another aspect, the persona corresponds to a genre of the audiovisual data.

According to another aspect, the persona corresponds to a time of day.

According to another aspect, the controller further controls the synthesizer to convert additional text data that is unrelated to the audiovisual data played back by the audiovisual data player so as to playback the additional text data to the user.

According to another aspect, the additional text data is announced between playback of a first unit of audiovisual data and a second unit of audiovisual data.

According to another aspect, the additional text data corresponds to a calendar event managed by a calendar function of the electronic equipment.

According to another aspect, the additional text data corresponds to a time managed by a clock function of the electronic equipment.

According to another aspect, the additional text data is obtained from a source external to the electronic equipment and corresponds to at least one of a news headline, a weather report, traffic information, a sports score or a stock price.

According to another aspect, the additional text data is preformatted for playback by the electronic equipment by a service provider.

According to another aspect, the additional text data is obtained by executing a search by an information retrieval function of the electronic equipment.

According to another aspect, the additional text data is played back in response to receiving a voice command from the user.

According to another aspect, the electronic equipment further includes a transceiver that receives the audiovisual data as a downstream for playback by the audiovisual data player.

According to another aspect, the electronic equipment is a mobile radio terminal.

According to another aspect of the invention, a method of playing audiovisual content to a user of an electronic equipment and announcing information associated with the audiovisual content includes playing back audiovisual data to the user; and converting text data associated with the audiovisual data into a representation of the text data and audibly playing back the representation to the user.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a schematic view of a mobile telephone as an exemplary electronic equipment in accordance with an embodiment of the present invention;

FIG. 2 is a schematic block diagram of the relevant portions of the mobile telephone of FIG. 1 in accordance with an embodiment of the present invention;

FIG. 3 is a schematic diagram of a communications system in which the mobile telephone of FIG. 1 may operate;

FIG. 4 is a schematic block diagram of another exemplary electronic equipment in accordance with an embodiment of the present invention; and

FIG. 5 is a flow chart of an exemplary audiovisual content announcement function in accordance with the present invention.

### DETAILED DESCRIPTION OF EMBODIMENTS

The present invention will now be described with reference to the drawings, wherein like reference numerals are used to refer to like elements throughout.

The term “electronic equipment” includes portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication apparatus or the like. Other exemplary electronic equipment may include, but are not limited to, portable media players, media jukeboxes and similar devices, and may or may not have a radio transceiver.

In the present application, the invention is described primarily in the context of a mobile telephone. However, it will be appreciated that the invention is not intended to be limited to a mobile telephone and can be any type of electronic equipment. Also, embodiments of the invention are described primarily in the context of announcing audio content. However, it will be appreciated that the invention is not intended to be limited to the announcement of audio content, and may be extended to announcing any information, such as announcing any form of audiovisual content. As used herein, audiovisual content expressly includes, but is not limited to, audio content derived from audio files or audio data, video content (with or without associated audio content) derived from video files or video data, and image content (e.g., a photograph) derived from an image file or image data.

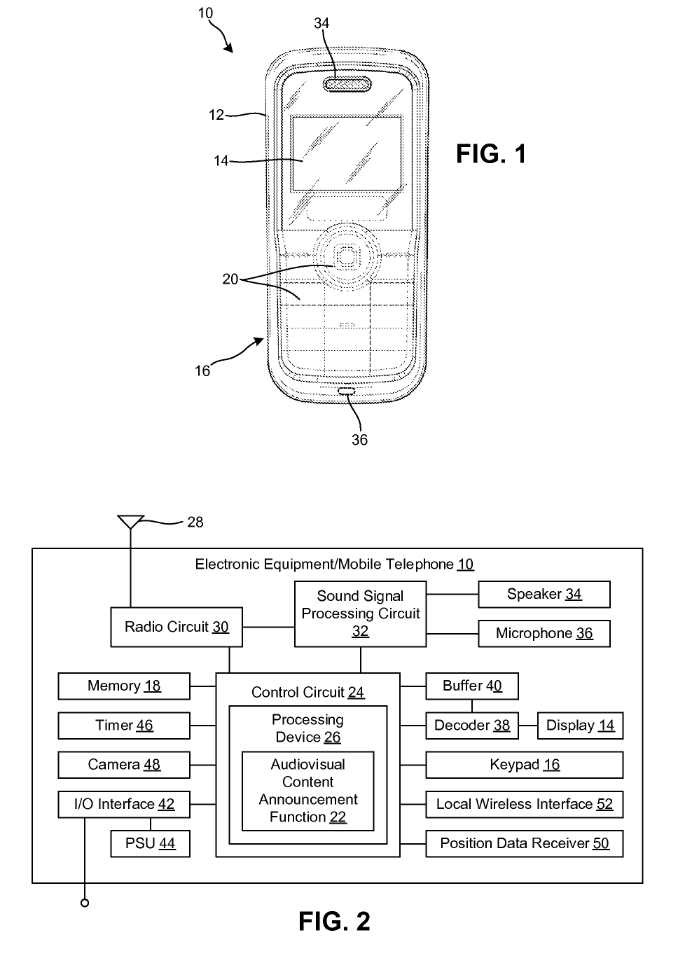

Referring initially to FIG. 1, an electronic equipment 10 is shown in accordance with the present invention. The electronic equipment includes an audiovisual content announcement function that is configured to provide a user with audible information corresponding to the playback or output of associated audiovisual content. It will be understood that playback of an audiovisual content relates to any manner of audiovisual content acquisition and includes, but is not limited to, reading audiovisual data from a locally stored file and receiving data from a transmission (e.g., an audio and/or video downstream, a mobile radio channel, a mobile television channel, an RSS feed, etc.). Thus, audiovisual files and/or audiovisual data may be obtained by file transfer, by downloading, from a podcast source, from a mobile radio or television channel and so forth. The audiovisual content announcement function may derive announced information from a header of the audiovisual file or audiovisual data. In addition to announcing information relating to an audiovisual file or audiovisual data, the audiovisual content announcement function may provide the user with additional audible information, such as sports scores, weather information, traffic information, news, calendar events, date and/or time, and so forth. The selection and timing of announcements may be configured so that the audiovisual content announcement function simulates a conventional radio disk jockey (DJ) and may be personalized for the user of the electronic equipment 10. The audiovisual data for each audiovisual file or each segment of received audiovisual data may be referred to as a unit of audiovisual data.

It will be appreciated that the audiovisual content announcement function may be embodied as executable code that may be resident in and executed by the electronic equipment 10. In other embodiments, as will be described in greater detail below, the audiovisual content announcement function (or portions of the function) may be resident in and executed by a server or device separate from the electronic equipment 10 (e.g., to conserve resources of the electronic equipment 10).

The electronic equipment in the exemplary embodiment of FIGS. 1-3 is a mobile telephone and will be referred to as the mobile telephone 10. The mobile telephone 10 is shown as having a “brick” or “block” form factor housing 12, but it will be appreciated that other type housings, such as a clamshell housing or a slide-type housing, may be utilized.

The mobile telephone 10 includes a display 14 and keypad 16. As is conventional, the display 14 displays information to a user such as operating state, time, telephone numbers, contact information, various navigational menus, etc., which enable the user to utilize the various feature of the mobile telephone 10. The display 14 may also be used to visually display content received by the mobile telephone 10 and/or retrieved from a memory 18 (FIG. 2) of the mobile telephone 10.

Similarly, the keypad 16 may be conventional in that it provides for a variety of user input operations. For example, the keypad 16 typically includes alphanumeric keys 20 for allowing entry of alphanumeric information such as telephone numbers, phone lists, contact information, notes, etc. In addition, the keypad 16 typically includes special function keys such as a “call send” key for initiating or answering a call, and a “call end” key for ending or “hanging up” a call. Special function keys may also include menu navigation keys, for example, for navigating through a menu displayed on the display 14 to select different telephone functions, profiles, settings, etc., as is conventional. Other keys associated with the mobile telephone may include a volume key, an audio mute key, an on/off power key, a web browser launch key, a camera key, etc. Keys or key-like functionality may also be embodied as a touch screen associated with the display 14.

The mobile telephone 10 includes conventional call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc.

FIG. 2 represents a functional block diagram of the mobile telephone 10. With the exception of an audiovisual content announcement function 22, which is preferably implemented as executable logic in the form of application software or code within the mobile telephone 10, the construction of the mobile telephone 10 may be otherwise generally conventional. The mobile telephone 10 includes a primary control circuit 24 that is configured to carry out overall control of the functions and operations of the mobile telephone 10. The control circuit 24 may include a processing device 26, such as a CPU, microcontroller or microprocessor. The processing device 26 executes code stored in a memory (not shown) within the control circuit 24 and/or in a separate memory, such as memory 18, in order to carry out conventional operation of the mobile telephone 10. The memory 18 may be, for example, one or more of a buffer, a flash memory, a hard drive, a removable media, a volatile memory, a non-volatile memory or other suitable device. In addition, the processing device 26 executes code in order to perform the audiovisual content announcement function 22.

It will be apparent to a person having ordinary skill in the art of computer programming, and specifically in applications programming for mobile telephones or other electronic devices, how to program a mobile telephone 10 to operate and carry out the functions described herein. Accordingly, details as to the specific programming code have been left out for the sake of brevity. Also, while the audiovisual content announcement function 22 is executed by the processing device 26 in accordance with the preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 28 coupled to a radio circuit 30. The radio circuit 30 includes a radio frequency transmitter and receiver for transmitting and receiving signals via the antenna 28 as is conventional. The radio circuit 30 may be configured to operate in a mobile communications system, as well as to receive audiovisual content. For example, the receiver may be an IP datacast compatible receiver compatible with a hybrid network structure providing mobile communications and digital broadcast services, such as DVB-H mobile television and/or mobile radio. Other receivers for interaction with a mobile radio network or broadcasting network are possible and include, for example, GSM, CDMA, WCDMA, MBMS, WiFi, WiMax, DVB-H, ISDB-T, etc.

The mobile telephone 10 further includes a sound signal processing circuit 32 for processing audio signals transmitted by/received from the radio circuit 30. Coupled to the sound processing circuit 32 are a speaker 34 and a microphone 36 that enable a user to listen and speak via the mobile telephone 10 as is conventional. The radio circuit 30 and sound processing circuit 32 are each coupled to the control circuit 24 so as to carry out overall operation. Audio data may be passed from the control circuit 24 to the sound signal processing circuit 32 for playback to the user. The audio data may include, for example, audio data from an audio file stored by the memory 18 and retrieved by the control circuit 24. The sound processing circuit 32 may include any appropriate buffers, decoders, amplifiers and so forth.

The mobile telephone 10 also includes the aforementioned display 14 and keypad 16 coupled to the control circuit 24. The display 14 may be coupled to the control circuit 24 by a video decoder 38 that converts video data to a video signal used to drive the display 14. The video data may be generated by the control circuit 24, retrieved from a video file that is stored in the memory 18, derived from an incoming video data stream received by the radio circuit 30 or obtained by any other suitable method. Prior to being fed to the decoder 38, the video data may be buffered in a buffer 40.

The mobile telephone 10 further includes one or more I/O interface(s) 42. The I/O interface(s) 42 may be in the form of typical mobile telephone I/O interfaces and may include one or more electrical connectors. As is typical, the I/O interface(s) 42 may be used to couple the mobile telephone 10 to a battery charger to charge a battery of a power supply unit (PSU) 44 within the mobile telephone 10. In addition, or in the alternative, the I/O interface(s) 42 may serve to connect the mobile telephone 10 to a wired personal hands-free adaptor (not shown), such as a headset (sometimes referred to as an earset) to audibly output sound signals output by the sound processing circuit 32 to the user. Further, the I/O interface(s) 42 may serve to connect the mobile telephone 10 to a personal computer or other device via a data cable. The mobile telephone 10 may receive operating power via the I/O interface(s) 42 when connected to a vehicle power adapter or an electricity outlet power adapter.

The mobile telephone 10 may also include a timer 46 for carrying out timing functions. Such functions may include timing the durations of calls, generating the content of time and date stamps, etc. The mobile telephone 10 may include a camera 48 for taking digital pictures and/or movies. Image and/or video files corresponding to the pictures and/or movies may be stored in the memory 18. The mobile telephone 10 also may include a position data receiver 50, such as a global positioning system (GPS) receiver, Galileo satellite system receiver or the like. The mobile telephone 10 also may include a local wireless interface 52, such as an infrared transceiver and/or an RF adaptor (e.g., a Bluetooth adapter), for establishing communication with an accessory, a hands-free adaptor (e.g., a headset that may audibly output sounds corresponding to audio data transferred from the mobile telephone 10 to the adapter), another mobile radio terminal, a computer or another device.

The mobile telephone 10 may be configured to transmit, receive and process data, such as text messages (e.g., a short message service (SMS) formatted message), electronic mail messages, multimedia messages (e.g., a multimedia messaging service (MMS) formatted message), image files, video files, audio files, ring tones, streaming audio, streaming video, data feeds (including podcasts) and so forth. Processing such data may include storing the data in the memory 18, executing applications to allow user interaction with data, displaying video and/or image content associated with the data, outputting audio sounds associated with the data and so forth.

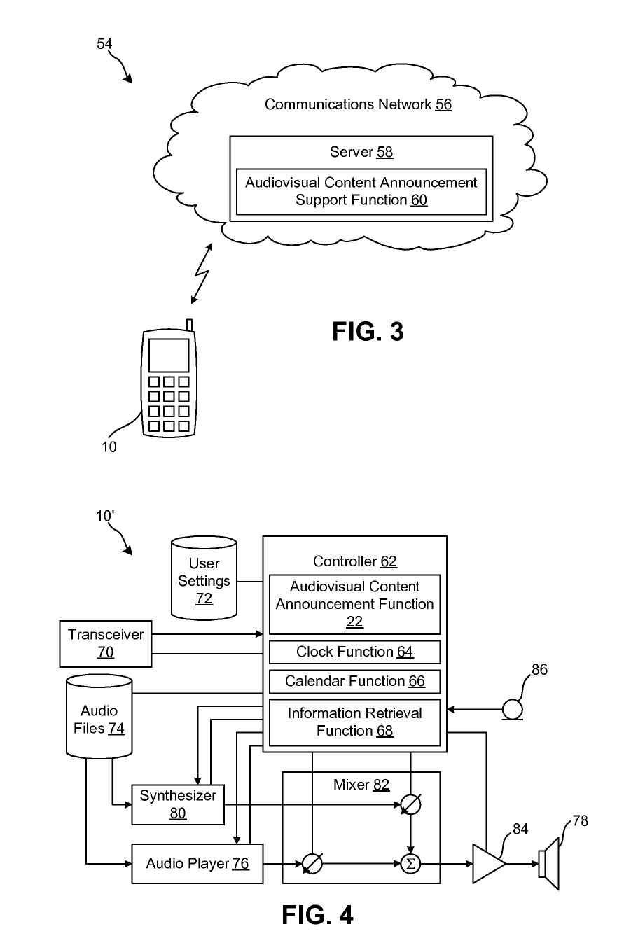

With additional reference to FIG. 3, the mobile telephone 10 may be configured to operate as part of a communications system 54. The system 54 may include a communications network 56 having a server 58 (or servers) for managing calls placed by and destined to the mobile telephone 10, transmitting data to the mobile telephone 10 and carrying out any other support functions. The server communicates with the mobile telephone 10 via a transmission medium. The transmission medium may be any appropriate device or assembly, including, for example, a communications tower, another mobile telephone, a wireless access point, a satellite, etc. Portions of the network may include wireless transmission pathways. The network 56 may support the communications activity of multiple mobile telephones 10, although only one mobile telephone 10 is shown in the illustration of FIG. 3.

In one embodiment, the server 58 may operate in stand alone configuration relative to other servers of the network 52 or may be configured to carry out multiple communications network 58 functions. As will be appreciated, the server 58 may be configured as a typical computer system used to carry out server functions and may include a processor configured to execute software containing logical instructions that embody the functions of the server 58. Those functions may include a portion of the audiovisual content announcement functions described herein in an embodiment where the audiovisual content announcement function 22 is not carried out by the mobile telephone 10 or is partially carried out by the mobile telephone 10 and/or where the server functions are complimentary to the operation of the audiovisual content announcement function 22 of the mobile telephone 10, and will be collectively referred to as an audiovisual content announcement support function 60.

Referring to FIG. 4, a block diagram of an exemplary electronic equipment 10′ for audibly announcing information is illustrated. In FIG. 4, exemplary control signal pathways are illustrated using lines without arrows and exemplary audio data and/or audio signal pathways are illustrated using lines with arrows. As indicated, the following description refers to the playback of audio content and announcing information associated therewith. However, the invention is not so limited and applies to audibly announcing any type of audiovisual content and/or additional information.

The electronic equipment 10′ may be embodied as the mobile telephone 10, in which case the illustrated components may be implemented in the above-described components of the mobile telephone 10 and/or in added components. As will be appreciated, in other embodiments, the electronic equipment 10′ may be configured as a media content player (e.g., an MP3 player), a PDA, or any other suitable device. Illustrated components of the electronic equipment 10′ may be implemented in any suitable form for the component, including, but not limited to, software (e.g., a program stored by a computer readable medium), firmware, hardware (e.g., circuit components, integrated circuits, etc.), data stored by a memory, etc. In other embodiments, some of the functions described in connection with FIG. 4 may be carried out outside the electronic equipment 10′. Accordingly, some of the components shown in FIG. 4 may be embodied as a part of an audiovisual content announcement function (e.g., the audiovisual content announcement function 22) resident in the electronic equipment 10′ or as part of an audiovisual content announcement function (e.g., the audiovisual content announcement support function 60) resident in an networked device, such as the server 58.

The electronic equipment 10′ may include a controller 62. The controller 62 may include a processor (not shown) for executing logical instructions and a memory (not shown) for storing code that implements the logical instructions. For example, in the embodiment in which the electronic equipment 10′ is the mobile telephone 10, the controller 62 may be the control circuit 24, the processor may be the processing device 26 and the memory may be a memory of the control circuit 24 and/or the memory 18.

The controller 62 may execute logical instructions to carry out the various information announcement functions described herein. These functions may include, but are not limited to, the audiovisual content announcement function 22, a clock function 64, a calendar function 66 and an information retrieval function 68. The audiovisual content announcement function 22 can control overall operation of playing back audio content to the user and oversee the various other audio functions of the electronic equipment 1′. The clock function 64 may keep the date and time. In the embodiment in which the electronic equipment 10′ is the mobile telephone 10, the clock function 66 may be implemented by the timer 46. The calendar function 66 may keep track of various events of importance to the user, such as appointments, birthdays, anniversaries, etc., and may operate as a generally conventional electronic calendar or day planner.

The information retrieval function 68 may be configured to retrieve information from an external device. For instance, the information retrieval function 68 may be responsible for obtaining weather information, news, community events, sport information and so forth. In one embodiment, the source of the information may be a server with which the electronic equipment 10′ communicates, such as the server 58 or an Internet server. As will become more apparent below, information retrieved by the information retrieval function 68 may be preformatted (e.g., by a data service provider) for coordination with the audiovisual content announcement function 22 or derived from results received in reply to a query made by the information retrieval function 22. In one embodiment, the information retrieval function 68 may include a browser function for interaction with Internet servers, such as a WAP browser. In other embodiment, information received by the electronic equipment 10′ for use by the audiovisual content announcement function 22 is derived from a service provider and may be push delivered to the electronic equipment 10′, such as in the form of an SMS or MMS, or as part of a downstream.

The electronic equipment 10′ may further include a transceiver 70. In the embodiment in which the electronic equipment 10′ is the mobile telephone 10, the transceiver 70 may be implemented by the radio circuit 30. The transceiver 30 may be configured to receive audiovisual data for playback to the user, including, for example, downloaded or push delivered audiovisual files and streaming audiovisual content. In addition, the transceiver 70 may be configured to provide a data exchange platform for the information retrieval function 68.

The electronic equipment 10′ may further include user settings 72 containing data regarding how certain operational aspects of the audiovisual content announcement function 22 should be carried out. The user settings 72 may be stored by a memory. For example, in the embodiment in which the electronic equipment 10′ is the mobile telephone 10, the user settings 72 may be stored by the memory 18.

The electronic equipment 10′ may further include audio files 74 containing audio data for playback to the user. The audio files 74 typically may be songs that are stored in an appropriate file format, such as MP3. Other formats may include, for example, WAV, WMA, ACC, MP4 and so forth. Other types of content and file formats are possible. For instance, the audio files may be podcasts, ring tones, files or other audio data containing music, news reports, academic lectures and so forth. The audio files 74 may be stored by a memory. For example, in the embodiment where the electronic equipment 10′ is the mobile telephone 10, the audio files 74 may be stored by the memory 18.

Again, it will be appreciated that the invention applies to other types of audiovisual content in addition to audio content. The description and illustration of audio files 74 and audio content handling is for exemplary purposes. They type of content to which the invention applies is only limited by the scope of the claims appended hereto.

Audio data for playback to the user need not be stored in the form of an audio file, but may be received using the receiver 70, such as in the form of streaming audio data, for playback to the user. Playback of received audio data may not involve storing of the audio data in the form of an audio file 74, although temporary buffering of such audio data may be made.

The audio files 74 and received audio data may include a header containing information about the corresponding audio data. For example, for a music (e.g., song) file, the header may describe the title of the song, the artist, the album on which the song was released and the year of recording. Table 1 sets forth an ID3v1 header for the MP3 file format.

TABLE 1

| Field | Offset (Bytes) | Length (Bytes) | Field Content Description |
|---|---|---|---|
| 1 | 0 | 3 | Tag identifier string |
| 2 | 3 | 30 | Song title string |
| 3 | 33 | 30 | Artist string |
| 4 | 63 | 30 | Album string |
| 5 | 93 | 4 | Year string |
| 6 | 97 | 30 | Comment string |
| 7 | 127 | 1 | Genre byte |

The electronic equipment 10′ may further include an audio player 76. The audio player 76 may convert digital audio data from the audio files 74 or received audio data into an analog audio signal used to drive a speaker 78. The audio player 76 may include, for example, a buffer and an audio decoder. In the embodiment in which the electronic equipment 10′ is the mobile telephone 10, the audio player 76 may be the sound signal processing circuit 32. In the embodiment in which the electronic equipment 10′ is the mobile telephone 10, the speaker 78 may be the speaker 34.

The electronic equipment 10 may further include a text to speech synthesizer 80. The synthesizer 80 may be used to convert audio file header information or other text data to an analog audio signal used to drive the speaker 78. The synthesizer may include speech synthesis technology embodied by a text-to-speech engine front end that converts the text data into a symbolic linguistic representation of the text and a back end that converts the representation to the sound output signal. As will be appreciated, the synthesizer 80 may be implemented in software and/or hardware. A portion of the synthesizer functions may be carried out by the controller 62.

The electronic equipment 10′ may further include an audio mixer 82 that combines the output of the audio player 76 and the synthesizer 80 in proportion to one another under the control of the controller 62. As such, the mixer 82 may be controlled such that the output heard by the user can be derived solely from the audio file 74 (or received audio data) or derived solely from the synthesizer 80. Also, the mixer may be used so that the user hears outputs from both the audio player 76 and the synthesizer 80, in which case the relative volumes of the audio file content (or received audio data content) and the synthesizer output are controlled relative to one another. The output of the mixer 82 may be input to an amplifier 84 to control the output volume of the speaker 78.

The electronic equipment 10′ may further include a microphone 86. The microphone 86 may be used to receive voice responses from the user to questions presented to the user from the audiovisual content announcement function 22 and/or receive commands from the user. The user input may be processed by a speech recognition component of the audiovisual content announcement function 22 to interpret the input and carry out a corresponding action. In the embodiment where the electronic equipment 10′ is the mobile telephone 10, the microphone 86 may be the microphone 36.

As will be appreciated, other configurations for the electronic equipment 10′ are possible and include, for example, arrangements to allow playback of the audio content from a selected audio file 74 (or received audio file) and synthesized audio content using a wired or wireless headset.

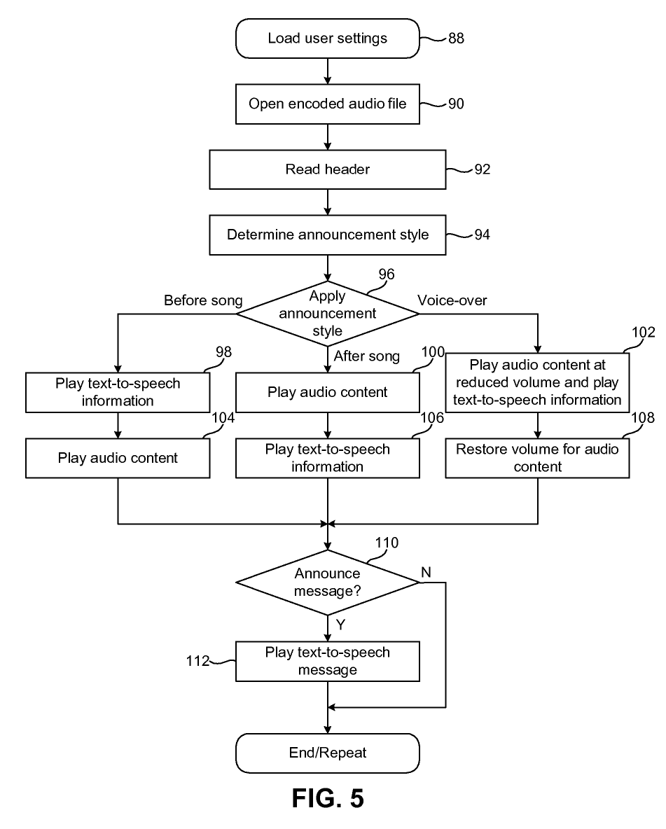

With additional reference to FIG. 5, exemplary operational functions of the electronic equipment 10′ will be described. Continuing with the example of playing back audio data, the operational functions include converting text information to speech in conjunction with the playback of audio data. In this manner, the electronic equipment 10′ may be considered to generate a simulated DJ (or, more generally, a simulated audiovisual content announcer). Audio file header data may be used to audibly inform the user of information relating to music that was just played, about to be played or is currently playing. Also, additional information may be audibly presented to the user to inform the user of the information. Such additional information may include, for example, the time, date, weather, traffic, news, the user's own calendar events, community events, and so forth.

FIG. 5 illustrates a flow chart of logical blocks for execution by the audiovisual content announcement function 22 and/or other functions, and may be thought of as depicting steps of a method. Although FIG. 5 shows a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

The method may begin in block 88 where the user settings 72 are loaded. The user settings 72 contain data regarding how and when the audiovisual content announcement function 22 audibly announces information to the user, as well as what information to announce to the user. For instance, the user settings 72 may set a persona to the voice used to announce the information. Exemplary persona settings may include the gender of the voice (male or female), the language spoken, the “personality” of the voice and so forth. The personality of the voice may be configured by adjusting the volume, pitch, speed, accent and inflection used by the audiovisual content announcement function 22 when controlling the synthesizer 80 to convert text to speech. The persona may be associated with a personality type, such as witty, serious, chirpy, calm and so forth. Options may be available for the user to alter these parameters directly and/or the user may be able to choose from predetermined persona genres, such as a “country” persona (e.g., when playing country music audio files), a “clam and smooth” persona (e.g., when playing jazz), a high energy “rock-n-roll” person (e.g., for pop or rock music), a business-like “professional” persona (e.g., for reciting news), a “hip-hop” persona, and so forth. Settings may be made to automatically change the persona according to the content of audio files and/or audio data that is played back, based on the time of day and so forth. In one example, a chirpier persona may be used with faster music and news reports for morning announcements and a calm persona may be used with slower music for evening announcements.

Other user settings 72 may control when and what header information is announced. For instance, the user may select to hear header information before audio data playback (e.g., playing of a song), after playback, during a song as a voice over to a song introduction or song ending, or randomly from these choices. The user may select to hear one or more of the name of the artist, the name of the song, the album on which the song was released and so forth.

The user settings 72 may control when and what additional information is announced and the source of the information. For example, the user may select to hear local weather reports once an hour, local traffic reports approximately every ten minutes during the user's typical commuting times, news headlines every thirty minutes and the types of news headlines announced (e.g., international events, local events, sports, politics, entertainment and celebrity, etc.), stock prices for selected stocks on a periodic basis or if the stock price moves by a predetermined amount, sports scores for a selected team when the team is playing, and so forth.

As will be appreciated, the user settings alone, default settings alone or a combination of user settings and default settings may be used to construct a personalized automated announcer to announce information of interest to the user, including information associated with an audio file or received audio data (e.g., header data) and information from an information source (e.g., a dedicated information service provider or a searchable information source).

With continuing reference to the figures, in block 90, an audio file 74 may be opened. It is noted that the illustrated method refers to playback of a stored audio file 74. However, it will be appreciated that the method may apply to playback of a received audio file or received audio data that does not become locally stored by the electronic equipment 10′. Any modifications to the illustrated method to carry out personalized announcement function for received audio files and/or data will be apparent to one of ordinary skill in the art. When playing back received audio data, opening of the file may not occur, but receipt and playback operations may be carried out.

In block 92, the header portion of the opened audio file (or received audio data) is read. Reading of the header may include extracting the text information from the header. Thereafter, an announcement style for all or some of the header as determined by the user settings 72 may be determined in block 94. As indicated, the announcement style may include the persona used to audibly announce the information, when to announce the information and which fields from the header to announce.

In block 96, the announcement style is applied by proceeding to the next appropriate logic block. For example, if the announcement style indicates announcing the information relating to the audio file (or received audio data) before playback of the corresponding data, the logical flow may proceed to block 98. If the announcement style indicates announcing the information relating to the audio file (or received audio data) after playback of the corresponding data, the logical flow may proceed to block 100. If the announcement style indicates announcing the information relating to the audio file (or received audio data) during playback of the corresponding data as a voice-over feature, the logical flow may proceed to block 102. The announcement style may indicate that the playback timing relative to the information announcement is to consistently use one timing option, use a rotating timing option selection or randomly select a timing option.

If the timing option advances the logical flow to block 98, the header information may be converted from text data to speech, which is audibly output to the user. The announcement may use certain information from the header and present the information in a familiar DJ style announcement. For instance, header information may be used to complete variable portions of predetermined phrases used to announce the audio file (or received audio data). The predetermined phrase may be stored text data that is merged with header data for “reading” by the synthesizer. For instance, stored text for a country song may be formatted as: “Up next, a classic country tune. Here's”/artist/“/s”/title/. In the foregoing, the quoted portions are stored text and the variable portions for completion using header data are bound by slashes. Upon merging of the stored text data and the header data, a complete announcement may be constructed for audible output to the user. In another embodiment, the prestored text may be replaced with audio data so that the audio content announcement is made up of played audio data and converted header information. In either case, “filler audio” that is generated from stored text or audio data is used in combination with header information to simulate a human announcer. Filler audio is not limited to linguistic speech, but includes sound effects, announcer mannerisms (e.g., whistling, Homer Simpson's “Doh!”, etc.), background music and so forth. Thus, an announcement may be made up from any one or more of header information, audio data and converted text.

Continuing the example of announcing audio content, if the audio file were for the song “Dusty” by

The Seldom Scene, which was released on the album Scene It All, the audiovisual content announcement function 22 could output the following synthesized statement: “From Seldom Scene's Scene It All album, here's ‘Dusty’.” Subsequent audio iles could be announced using alternative phrasing and/or an alternate set of header information, such as: “This is ‘Nobody But You’ by Asie Payton.” In this example, only the song title and artist are mentioned and the album is ignored. As another example, the simulated announcer may say: “Next is ‘Antonin Dvorak Symphony No. 7 in D Minor’ recorded by the Cleveland Orchestra at Severance Hall in 1997. Conductor Christoph von Dohnany.”

The announcement of block 98 may be made using various announcement style parameters appropriate for the announcement, such as the announcement persona, the genre of music associated with the audio content, and so forth. Following block 98, the logic flow may proceed to block 104 where the audio content derived from the audio file 74 (or received audio data) is played.

Returning to block 96, if the timing option advances the logical flow to block 100, the audio content derived from the audio file 74 (or received audio data) is played. After playback of the audio file (or received audio data) is completed, the logical flow may proceed to block 106 to announce information corresponding to the audio file 74 (or received audio data) that was played in block 100. The announcement of block 106 may be made in the same or similar manner to the announcement of block 98 and, therefore, additional details of the block 106 announcement will not be discussed in greater detail for the sake of brevity.

Returning to block 96, if the timing option advances the logical flow to block 102, the audio content derived from the audio file 74 (or received audio data) is played. At an appropriate time in the playback, such as at the beginning or end of the playback, the volume of the played back audio content may be reduced and an announcement of information corresponding to the audio file 74 (or received audio data) is played as a voice-over to the audio content. The announcement of block 102 may be made in the same or similar manner to the announcement of block 98 and, therefore, additional details of the block 102 announcement will not be discussed in greater detail for the sake of brevity. Following the information announcement, the volume for the audio content playback may be restored in block 108.

Following blocks 104, 106 or 108, the logical flow may proceed to block 110. In block 110, a determination may be made as to whether the audiovisual content announcement function 22 should announce a message to the user. For example, the user settings 72 may indicate that announcement of information such as a weather report, stock price, news headline, sports score, the current time and/or date, commercial advertisement or other information may be appropriate. In one embodiment, the information retrieval function 68 may identify news items regarding the artist of the previously played audio file. If a current news item is identified, a positive result may be established in block 110. In a variation, any upcoming live appearances of the artist in the user's location may be identified and used as message content.

Another information item for announcement in an audible message may be an upcoming event that the user has logged in the calendar function 66. For example, the message could be a reminder that the next day is someone's birthday, a holiday or that the user has a meeting scheduled for a certain time. The user settings 72 may indicate when and how often to announce an upcoming calendar event, such as approximately sixty minutes and ten minutes before a meeting. Other personal reminders may be placed in audible message form, such as a reminder to stop for a certain item during a commute home from work.

If a positive determination is made in block 110, the logical flow may proceed to block 112 where the message is played to the user. In most cases, text data is converted to speech for audible playback to the user. However, the message could be recorded audio data, such as a voice message received from a caller, audio data recorded by a service provider, a commercial advertisement and so forth. A combination of converted text and audio data (e.g., audio filler as discussed above) may be used to construct the message.

After block 112, or if a negative determination is made in block 110, the logical flow may end. Alternatively, the logical flow may return to block 88 or 90 to initiate playback of another audio file (or received audio data). In this embodiment and where the playback of audio content in blocks 110, 102 or 104 is for received audio data from a mobile radio channed, the audiovisual content announcement function 22 may be configured to continue to use a current mobile radio channel or select another mobile radio channel. If the channel is changed, the change may be announced to the user. The selected mobile radio channel may be made randomly, by following an order of potential channels or selected based on current or upcoming content. The channels from which the selection is made may be established by the user and set forth in the user settings 72. In one embodiment, the audiovisual content announcement function 22 may be configured to interact with the mobile radio service provider to determine when one or more audio files from a corresponding channel(s) will commence and switch to an appropriate channel at an appropriate time. A time interval until the target content is received may be filled with audio announcements (e.g., header information possibly combined with audio filler) for the content and/or additional messages (e.g., weather, news, sports and/or other items of information).

In one embodiment, the audiovisual content announcement function 22 may be configured to receive and respond to voice commands of the user. Voice and/or speech recognition software may be used by the audiovisual content announcement function 22 to interpret the input from the user, which may be received using the microphone 86. For example, the user may be able to verbally select a next audio file or next mobile radio channel for playback, ask for the time, ask for a weather report and so forth. In another exemplary configuration, the audiovisual content announcement function 22 may play a message in block 112 and ask the user a follow-up question, to which the user may reply to invoke further appropriate action by the audiovisual content announcement function 22. As one example, the audible output may say “It is currently sunny and 73 degrees. Would you like a forecast?” In reply, the user may state “yes” to hear an extended forecast. Otherwise, the extended forecast will not be played out to the user.

The electronic equipment 10′, whether embodied as the mobile telephone 10 or some other device, audibly outputs information about an audiovisual file or received audiovisual data that is played back to the user and/or audibly outputs messages and other information to the user. The output may contain synthesized readings generated by a text to speech synthesizer. This may have advantage in situations where viewing information on a display may be distracting or not practical. Also, blind users may find the personalized, automated announcer functions described herein to be particularly useful. The personalized announcer functions may be entertaining and informative to users, and the ability to configure the automated announcer persona may enhance the user experience. Randomization of when to output announcements, header information using the text-to-speech function, and/or when to output other information, as well as variations in the content of these outputs may further enhance the user experience by simulating a live DJ (e.g., simulate a conventional human announcer for a conventional radio station).

Although the invention has been shown and described with respect to certain embodiments, it is understood that equivalents and modifications will occur to others skilled in the art upon the reading and understanding of the specification. The present invention includes all such equivalents and modifications, and is limited only by the scope of the following claims.

What is claimed is:

1. A mobile radio terminal, comprising:
a radio circuit for enabling call completion between the mobile radio terminal and a called or calling device; and
a text-to-speech synthesizer for converting text data to a representation of the text data for audible playback of the text to a user.

2. The mobile radio terminal according to claim 1, wherein the converted text data is derived from a header associated with audiovisual data.

3. The mobile radio terminal according to claim 2, further comprising an audiovisual data player for playing the audiovisual data back to the user and wherein the converted text data is played back in association with playback of the audiovisual data to announce the audiovisual data to the user.

4. The mobile radio terminal according to claim 2, wherein the converted text data from the header is merged with filler audio to simulate a human announcer.

5. An electronic equipment for playing audiovisual content to a user and announcing information associated with the audiovisual content, comprising:
an audiovisual data player for playing back audiovisual data;
a synthesizer for converting text data associated with the audiovisual data into a representation of the text data for audible playback of the text to a user; and
a controller that controls the synthesizer and the audiovisual data player to play back the text data in association with playback of the audiovisual data to announce the audiovisual data to the user.

6. The electronic equipment of claim 5, wherein converted text data associated with the audiovisual data is merged with filler audio to simulate a human announcer.

7. The electronic equipment of claim 5, further comprising an audio mixer for combining an audio output of the audiovisual data player and an output of the synthesizer at respective volumes under the control of the controller.

8. The electronic equipment of claim 5, wherein the text data is audibly announced at a time selected from one of before playback of the audiovisual data, after playback of the audiovisual data or during the playback of the audiovisual data.

9. The electronic equipment of claim 5, wherein the text data is derived from a header of an audiovisual file containing the audiovisual data.

10. The electronic equipment of claim 9, further comprising a memory for storing the audiovisual file.

11. The electronic equipment of claim 5, wherein plural units of audiovisual data are played back and text data is played back for each audiovisual data unit playback, and the controller changes an announcement style of the text data playback from one audiovisual data playback to a following audiovisual data playback.

12. The electronic equipment of claim 5, wherein the controller controls the synthesizer to apply a persona to the conversion of the text data.

13. The electronic equipment of claim 12, wherein the persona corresponds to a genre of the audiovisual data.

14. The electronic equipment of claim 12, wherein the persona corresponds to a time of day.

15. The electronic equipment of claim 5, wherein the controller further controls the synthesizer to convert additional text data that is unrelated to the audiovisual data played back by the audiovisual data player so as to playback the additional text data to the user.

16. The electronic equipment of claim 15, wherein the additional text data is announced between playback of a first unit of audiovisual data and a second unit of audiovisual data.

17. The electronic equipment of claim 15, wherein the additional text data corresponds to a calendar event managed by a calendar function of the electronic equipment.

18. The electronic equipment of claim 15, wherein the additional text data corresponds to a time managed by a clock function of the electronic equipment.

19. The electronic equipment of claim 15, wherein the addition text data is obtained from a source external to the electronic equipment and corresponds to at least one of a news headline, a weather report, traffic information, a sports score or a stock price.

20. The electronic equipment of claim 19, wherein the additional text data is preformatted for playback by the electronic equipment by a service provider.

21. The electronic equipment of claim 19, wherein the additional text data is obtained by executing a search by an information retrieval function of the electronic equipment.

21. The electronic equipment of claim 15, wherein the additional text data is played back in response to receiving a voice command from the user.

23. The electronic equipment of claim 5, further comprising a transceiver that receives the audiovisual data as a downstream for playback by the audiovisual data player.

24. The electronic equipment of claim 5, wherein the electronic equipment is a mobile radio terminal.

25. A method of playing audiovisual content to a user of an electronic equipment and announcing information associated with the audiovisual content, comprising:
playing back audiovisual data to the user; and
converting text data associated with the audiovisual data into a representation of the text data and audibly playing back the representation to the user.
